(19) United States
(12) Patent Application Publication
(10) Pub. No.: US 2006/0277251 A1
(43) Pub. Date: Dec. 7, 2006

(54) Information processing apparatus and system development method

(75) Inventors: Takashi Tohyama, Kanagawa (JP); Takanobu Ouchi, Tokyo (JP)

Correspondence Address: YOUNG & THOMPSON, 745 SOUTH 23RD STREET, 2ND FLOOR, ARLINGTON, VA, 22202, US

(73) Assignee: ATRRIS CORPORATION, TOKYO (JP)

(21) Appl. No.: 11/445,188

(22) Filed: Jun. 2, 2006

(30) Foreign Application Priority Data
Jun. 3, 2005 (JP) 2005-163947

(51) Int. Cl. G06F 15/16

(52) U.S. Cl. 709/203

(57) ABSTRACT

Disclosed is an apparatus including a framework control unit for receiving design information, which defines design specifications (client process, action definition, permission definition, page definition, screen layout definition, etc.) of a target system to be built, from a storage unit and for controlling framework parts implemented on the system, thereby allowing the design information to be implemented on multiple different architectures using the same design information.

### FIELD OF THE INVENTION

The present invention relates to an information processing system, and more particularly to an apparatus and a method suitable for designing and developing system such as an enterprise system.

### DESCRIPTION OF THE RELATED ART

In a typical system development environment, the implementation of a target system, such as a client system, based on design information which defines specifications of the system, has been manually done and hence the implementation of the target system depends on the skill of an engineer in charge.

The client processing and the server logic are in general divided each other in the conventional system development environment. This requires that both interfaces be separately defined and implemented.

In addition, the design concept of a target system and the implementation concept of the target system are not clearly distinguished in design and development of the system. This sometimes results in a case in which the design depends largely on the limitation of the implementation or the system which has already been designed must be re-designed in the system implementation phase.

According to the conventional system development technique in which a system engineer manually converts the design information to the target system, as described above, there are large amount of variations in the design quality and the like, thereby making it extremely difficult to estimate accurately the man-hour required for system development. The dependence on engineer's skill also makes it difficult to reduce the development cost.

### SUMMARY OF THE INVENTION

Accordingly, it is an object of the present invention to provide an apparatus and method for formulating the conversion from design information to make it possible to build a target system.

The above and other objects are attained by an apparatus in accordance with one aspect of the present invention comprising:

a first storage unit for storing design information defining design specifications of a target system to be built;

a second storage unit for storing a plurality of implementation parts used for a system implementation; and

a control unit, receiving the design information from said first storage unit, for controlling the implementation parts corresponding to said design information to automatically build the target system being adapted for operation, based on said design information. The implemented system can operates as an actual machine. The control unit includes a virtual machine which implements a plurality of systems having different architectures, using the same design information.

In accordance with the present invention, the design information includes client process definition information, action definition information, and action permission right definition information.

In accordance with the present invention, the design information further includes definition information on a screen page and screen layout definition information corresponding to the page.

In accordance with the present invention, the apparatus may further comprise simulation means for performing design operation verification based on the definition information before actually implementing actions.

In accordance with the present invention, the apparatus may further comprise means for debugging the client.

In accordance with the present invention, the framework control unit controls framework parts corresponding to the definition information and directly implements the system based on the design information.

In accordance with the present invention, specifications for the screen layout can be changed without changing original design information by redefining the pages and the screen layout.

In accordance with the present invention, a client process has one or more contents, a predetermined stereotype attribute is set for each data list screen that can be edited, and input/output items required for the stereotype attribute are set.

In accordance with the present invention, the stereotype includes

a selection providing screen,

a data inquiry screen,

a data editing screen,

a data list inquiry screen,

an editable data list screen, and

an edition result introduction screen,

In accordance with the present invention, the process definition information includes the inter-process flow definition.

In accordance with the present invention, the action definition information includes an action name and processing to be executed.

In accordance with the present invention, the definition information on a screen page includes a page name, a client process, a screen layout, and page transition information.

In accordance with the present invention, the screen stereotype includes a selection providing screen, a data inquiry screen, an editing screen, a data list inquiry screen, an information display screen, a search condition, operation state, and confirmation dialog, a system error dialog, a warning dialog, a report screen, a start screen, and a login and logout screen.

In accordance with the present invention, GUI parts corresponding to screen stereotypes may be provided as framework parts.

In accordance with the present invention, the apparatus may further comprise means for receiving a stereotype corresponding to contents and for converting the stereotype to a processing command for a database, wherein the processing command is issued to the database.

A method according to another aspect of the present invention is a system development method that uses an information processing apparatus comprising a storage unit in which design information defining design specifications for a system to be built is stored and a controller, wherein the design information includes client process definition information, action definition information, action permission right definition information, definition information on a screen page, and screen layout definition information corresponding to the page. The system development method comprises the steps, by the controller, of reading the design information from the storage unit; controlling framework parts including user interfaces, screen layouts, and action programs; and performing framework control.

The meritorious effects of the present invention are summarized as follows.

The apparatus according to the present invention improves the design quality, prevents a specification miss and an inconsistency, and contributes to an increase in development efficiency.

The apparatus according to the present invention provides a configuration in which the client processing and the server business logic are processed transparently. The configuration, in which client processes are extracted from the use-case activity processes, allows the client processing and the server business logic processes to be dealt with transparently, thus making it possible to release a new system quickly with no need for individually modifying the client and the server, even in such a case wherein a new service is added or the specifications are changed.

The apparatus according to the present invention allows the user to design a client during the client design phase without considering the implementation. The information defined during the design phase can be input directly to the framework parts prepared for the implementation phase.

Furthermore, the apparatus according to the present invention, which provides the high abstraction level design feature, allows the design information to be implemented on different architectures using the same design information, with the result that the client design does not depend on the architecture of the client.

The apparatus according to the present invention separates an enterprise rule from enterprise processing and allows a client process to freely call the enterprise rule. Because the rule is managed separately from the client source code, the enterprise logic and the enterprise rule can be maintained and managed separately.

The apparatus according to the present invention reliably checks the design information before the implementation.

The apparatus according to the present invention allows the user to use the debug function, provided by the framework, to make the debugging easier.

The apparatus according to the present invention provides a regression or recursion test tool for use in a client to allow the user to test the client when the specifications are changed.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not restrictive.

### BRIEF DESCRIPTION OF THE DRAWINGS

FIG. 1 is a diagram showing clients in the three-layer structure in one embodiment of the present invention.

FIG. 2 is a diagram showing the cooperation among design processes in one embodiment of the present invention.

FIG. 3 is a diagram showing the design items of a client in one embodiment of the present invention.

FIG. 4 is a flowchart showing the design procedure of a client in one embodiment of the present invention.

FIG. 5 is a flowchart showing the abstraction design and the implementation of a client in one embodiment of the present invention.

FIG. 6 is a diagram showing an example of screen layout changes in one embodiment of the present invention.

FIG. 7 is a diagram showing an example of a client XML definition file in one embodiment of the present invention.

FIG. 8 is a diagram showing XML files defined in a client in one embodiment of the present invention.

FIG. 9 is a diagram showing an example of a process definition XML file in one embodiment of the present invention.

FIG. 10 is a diagram showing an example of an action definition XML file in one embodiment of the present invention.

FIG. 11 is a diagram showing an example of a permission definition XML file in one embodiment of the present invention.

FIG. 12 is a diagram showing an example of a page definition XML file in one embodiment of the present invention.

FIG. 13 is a diagram showing an example of a screen layout definition XML file in one embodiment of the present invention.

FIG. 14 is a diagram showing the configuration of a client control feature in one embodiment of the present invention.

FIG. 15 is a diagram showing an example of screen stereotypes in one embodiment of the present invention.

FIG. 16 is a diagram showing an example of GUI standard parts in one embodiment of the present invention.

FIG. 17 is a diagram showing an example of contents definition elements in one embodiment of the present invention.

### DESCRIPTION OF PREFERRED EMBODIMENTS

The present invention will be described more in detail with reference to the accompanying drawings. First, the design of a client in one embodiment of the present invention will be described. According to the present invention, a client is designed as follows:

(A1) The use-case analysis/design result is clearly reflected on the design of a client.

In the present embodiment, the work of reflecting design information on the design of a client is formulated to improve the design quality, and catalog data is used to prevent a specification miss and inconsistency.

(A2) The client processing and the server business logic cooperate with each other transparently.

The conventional technique, in which the client processing and the server logic are clearly divided, requires that both interfaces be individually defined and implemented. In contrast, the apparatus according to the present invention is structured to allow the client processing and the server logic process to be processed transparently. The client process is extracted from the use-case activity process in the present embodiment to allow the client processing and the serve logic process to be processed transparently. This method eliminates the need for individually modifying the client and the server when a new service is added or the specifications are changed, thereby making it possible to release a new system quickly.

(A3) The design phase and the implementation phase are clearly separated.

According to the present invention, the client design phase can be accomplished without considering the implementation. The framework parts prepared for the implementation phase have a function to directly receive the information defined in the design phase. This function allows the user to clearly separate the design phase and the implementation phase.

(A4) The client design does not depend on the implementation architecture.

Clearly separating the design phase and the implementation phase as described in (A3) makes it possible to greatly enhances the abstraction level of the design information. The high level abstraction design allows the same design information to be implemented on a client built on a different architecture.

(A5) An enterprise rule is separated from an enterprise processing so that the enterprise rule is able to be freely called by processes in a client.

A client can freely call the enterprise rule of the rule engine. Because the rule is managed separately from the source code of the client, the enterprise processing and the enterprise rule can be maintained separately.

(A6) The design information is completely checked before the implementation.

A design information checking tool is provided to completely check the client design result before the implementation.

(A7) Debugging becomes easy.

The debugging function provided by the framework realizes the easy debugging of the client.

(A8) The client is tested completely.

A regression (or recursion) test tool can be used in the client to completely test the client when the specifications are changed.

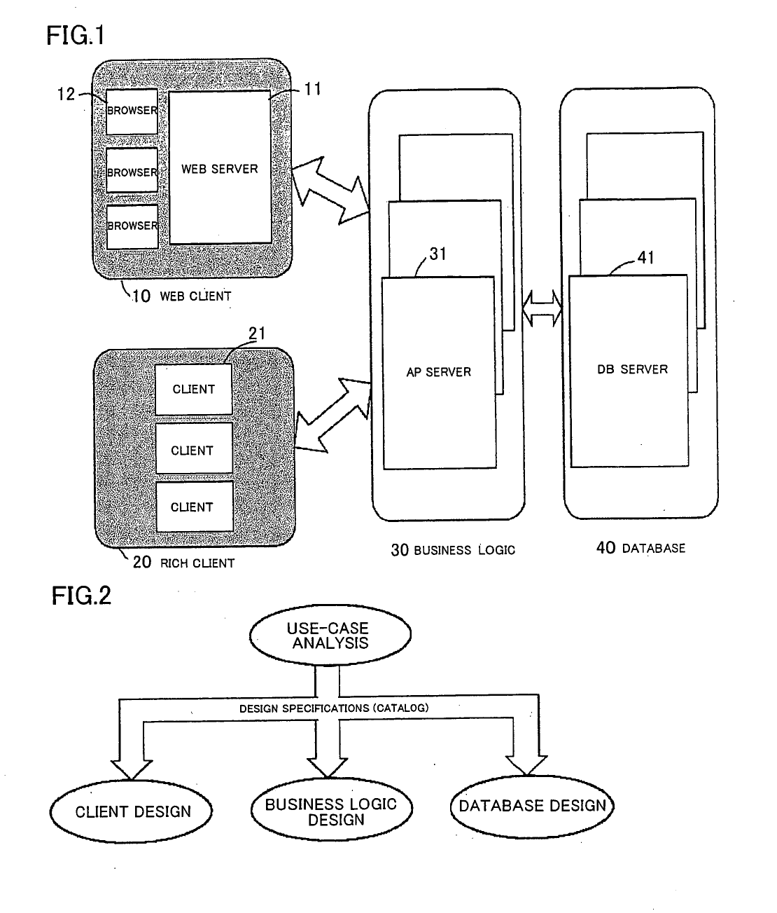

Next, the outline of client design in one embodiment of the present invention will be described. In the client design environment, the client parts of a three-layer system (client, business logic, and database) are designed as shown in FIG. 1.

Referring to FIG. 1, the design of clients (WEB client 10, and rich client 20), the design of a business logic (30), and the design of a database (40) cooperate with each other based on a predetermined rule.

An implementation scheme of a client is classified in two schemes: a web client (thin client) and a rich client. Form the viewpoint of software reuse and maintenance, the design scheme common to the two schemes is desirable.

<Cooperation among Design Processes>

FIG. 2 is a diagram showing the cooperation among design processes in the present embodiment. Not always but usually, when the design is based on the use-case analysis, the client design work is also based on the specifications prepared by the use-case analysis/design. This allows the design of the client and the design of other parts to cooperate with each other.

The design specifications are cataloged so that they can be used directly in the next design work. Each of the client design, the business logic design, and the database design is performed with the cataloged design information as its input.

<Design Items>

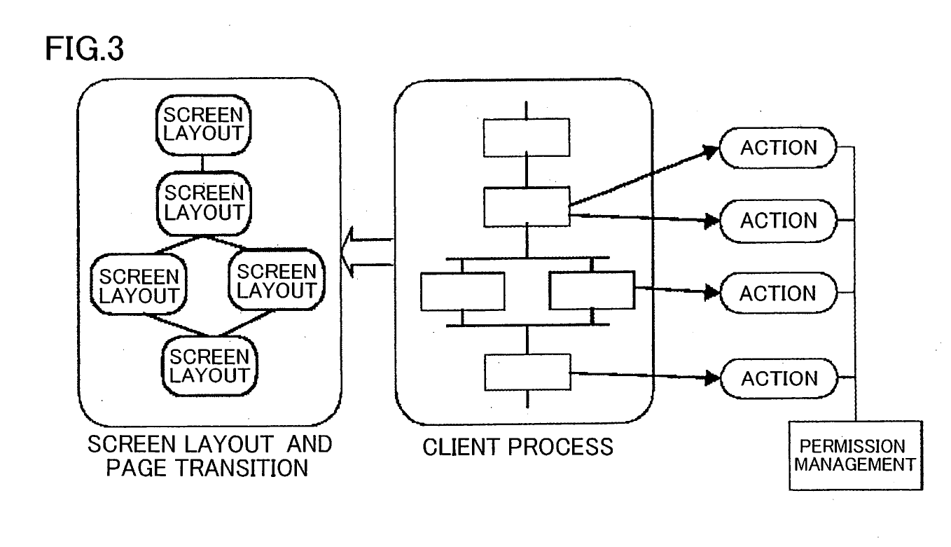

FIG. 3 is a diagram showing an example of client design items in the present embodiment. In the client design, the following items are designed as shown in FIG. 3.

(B1) Client Process

The client process-flow is created and the processes are designed.

(B2) Client Action

Processing for user (or system) actions is designed.

(B3) Permission Management

An action whose execution is limited by the permission assigned to a user and a terminal is defined.

(B4) Screen Page Transition, State Transition

The screen page transition and the state transition in the system to be designed are defined.

(B5) Screen Layout

The screen display form of the system to be designed is defined.

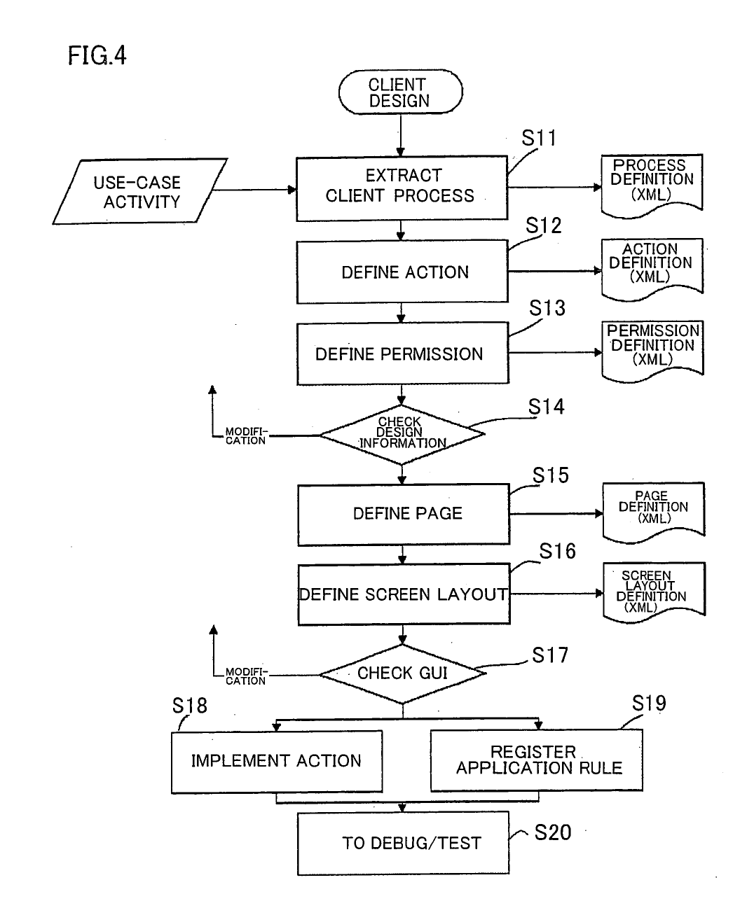

Next, the client design procedure in one embodiment of the present invention will be described. FIG. 4 is a flowchart showing the procedure for designing a client.

<Extract Client Process>

Client process is extracted based on the use-case activity created during the use-case analysis/design (step S11 in FIG. 4). In general, one or more client processes are extracted for each process of a use-case activity depending upon the process granularity of the use-case activity.

The extracted client processes are divided into several contents, and the stereotype attribute is defined for each contents. The types and the names of stereotype attributes are defined in advance.

The input/output enterprise items necessary for the stereotype attributes are defined. In this case, if an enterprise rule corresponds to an input/output enterprise item, the rule name is specified.

The flow (transition) among the processes is also defined in this step. The major items defined in this step are as follows.
Client process;
Contents;
Stereotype attribute;
Input/output enterprise item;
Application rule name; and
Process flow.
   <Define Action>

Next, an action for each client process is defined (step S12 in FIG. 4). An action is processing started by an operator's operation or an occurrence of a predetermined system event. In the description of the action, the processing to be performed for a defined action is specified. This description is implemented as a program in the later implementation phase.

The major items defined in this step are as follows.
Action name; and
Action processing.
   <Define Permission>

The type of limitation is defined and the permission is set when an action is limited (step S13 in FIG. 4). The major item defined in this step is the permission (limitation type).

The design information is checked and, if modification is required in some step, control is returned to one of steps S11-S13.

<Define Page>

Divide a client process into actual screen units, or merge client processes into an actual screen unit, to define a page (step S15 in FIG. 4). The page is determined according to the actual screen size or the selected client architecture. The page is made correspond to the screen layout. The major items defined in this step are as follows.
Page name;
Corresponding client process;
Corresponding screen layout; and
Page transition.
   <Define Screen Layout>

The layout of the screen that is made correspond to each page is defined (step S16 in FIG. 4). The placement information on the UI components corresponding to the stereotype of the client is defined for the screen layout.

<Abstraction Design and Change Processing>

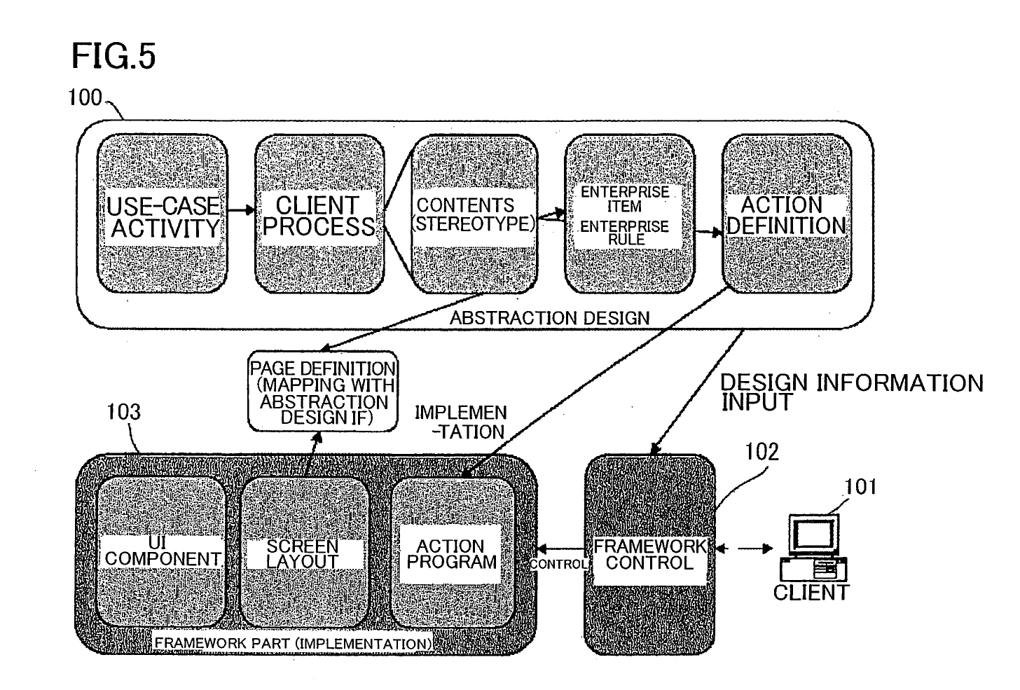

The client design procedure described above enables design abstraction. FIG. 5 shows how the design is abstracted.

A framework control unit 102 receives from a first storage unit 100 for storing design information (abstraction design), which includes a use activity analysis in UML, a client process definition, contents (stereotype screen), enterprise items/enterprise rules, and an action definition, as shown in FIG. 5, to control framework parts. The framework parts which are stored in a second storage unit 103 include UI components, screen layouts, and action programs that are the implementation of action definitions.

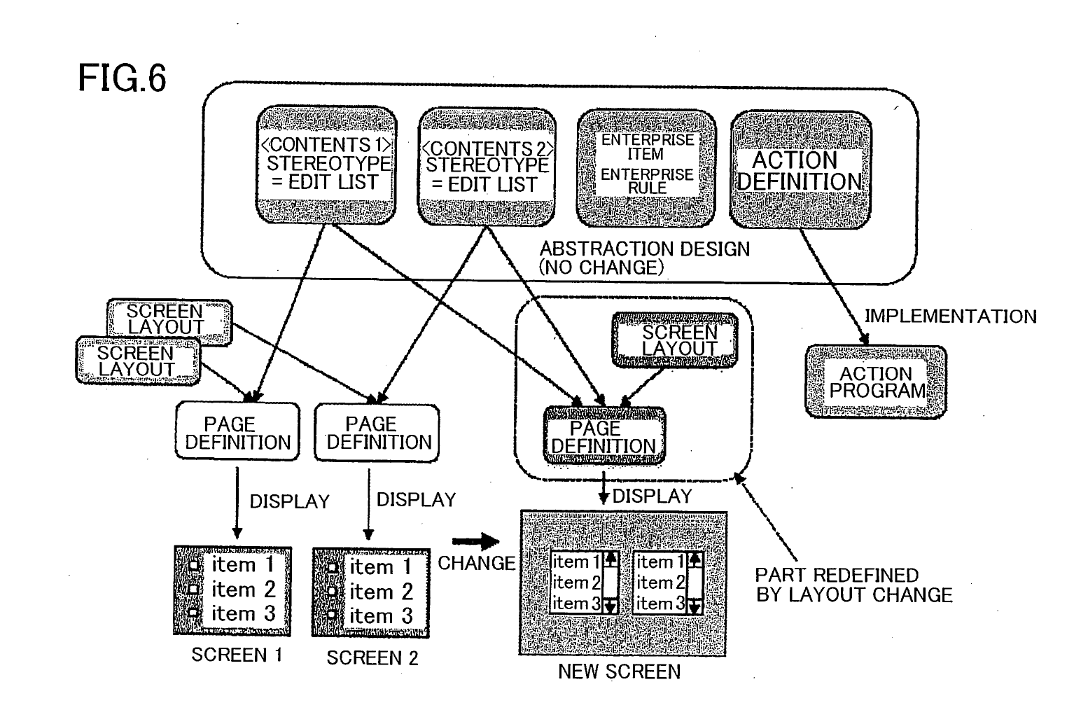

The introduction of the abstraction design into a client design makes it possible to easily change the specifications. FIG. 6 shows, as an example for changing the specifications, how the screen layout is changed. When screens 1 and 2 are going to be changed, the screen layouts and the page definitions need only be redefined to change the layout. This redefinition changes original screens 1 and 2 to the new screen as shown in FIG. 6.

<XML Definition>

In the present embodiment, the information designed during the client design step is defined in XML.

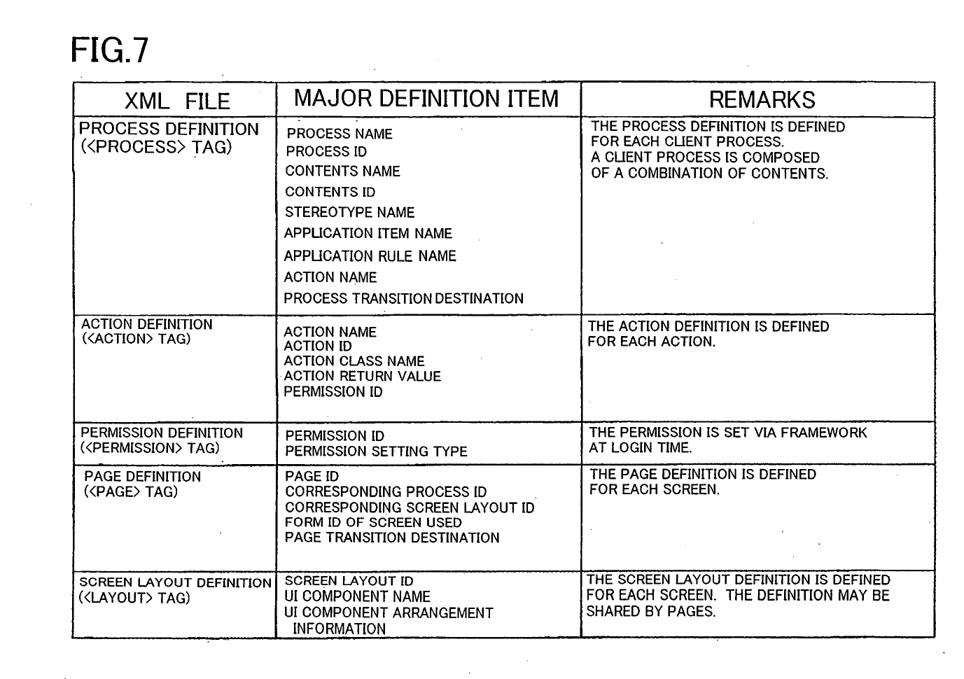

FIG. 7 is a diagram showing an example of the relation between the design information and the XML files. The table in this figure is composed of XML files [process definition (<process> tag), action definition (<action> tag), permission definition (<permission> tag), page definition (<page> tag), screen layout definition (<layout> tag)] and the definition items. Note that the permission (access right) is set via the framework at login time.

The information defined in XML is used for the following purposes.
HTML document generation;
Design rule checking;
Design information review information;
Input at operation manual creation time;
Operation checking before implementation via simulation; tool;
Information input to framework at execution time;
Template generation for implemented program; and
Regression test information creation.

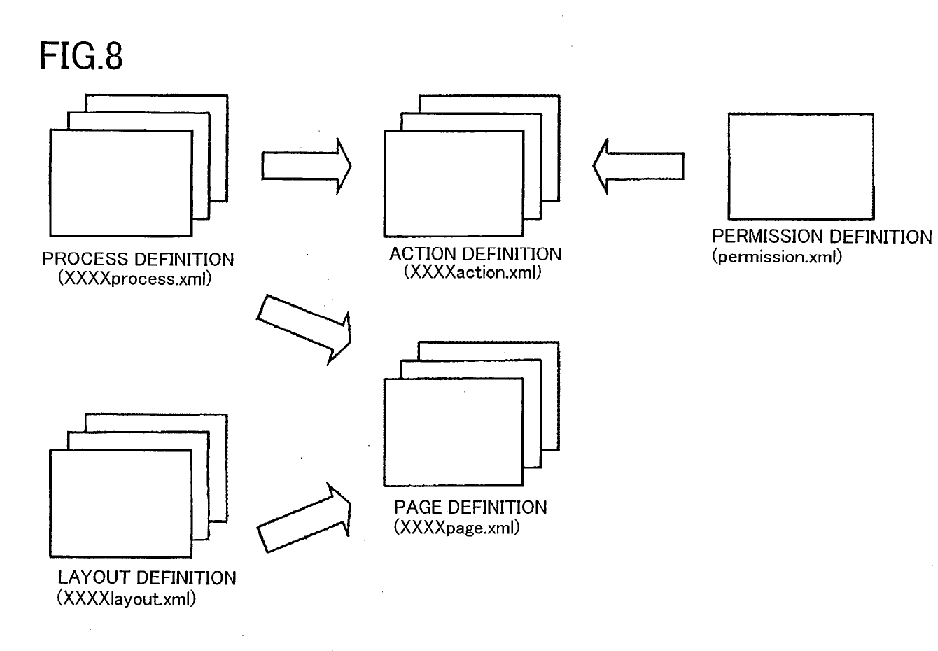

FIG. 8 is a diagram showing the XML files defined during the client design and the cross-reference relation among those files. The XML files include the process definition file, the action definition file, the permission definition file, the layout definition file, and the page definition file. The action definition file references the process definition file and the permission definition file, and the page definition file references the process definition file and the layout definition file.

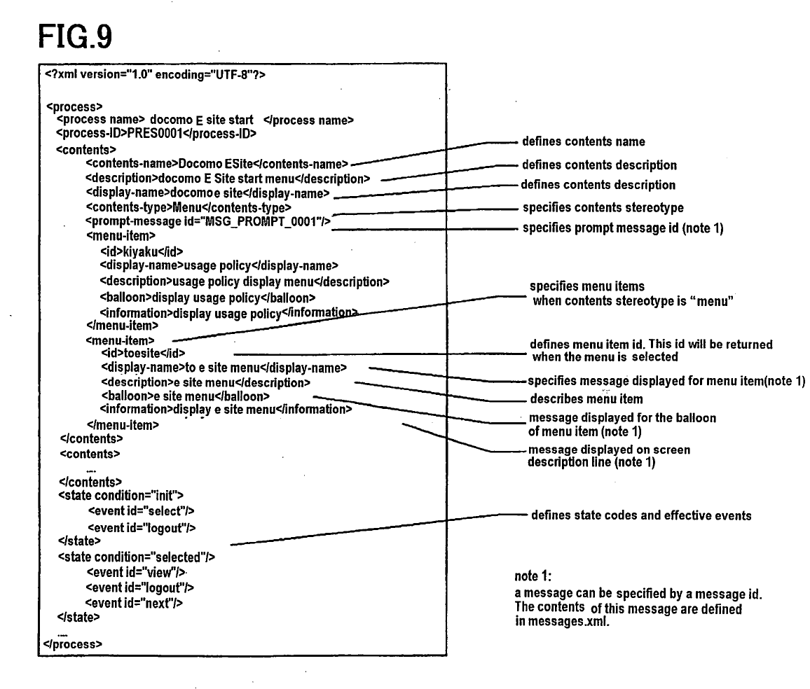

FIG. 9 is a diagram showing an example of the process definition XML file. This file defines the process name and the process ID and, under the <contents> tag, the contents name, the contents ID, and the contents stereotype (Menu in this case). In the example shown in FIG. 9 where the stereotype is “Menu”, the menu items are specified and, for each menu item, the menu item ID, the messages displayed for the menu item, and messages displayed on screen description lines are defined. In addition, the state codes and events are defined (<state condition> <event id> tag).

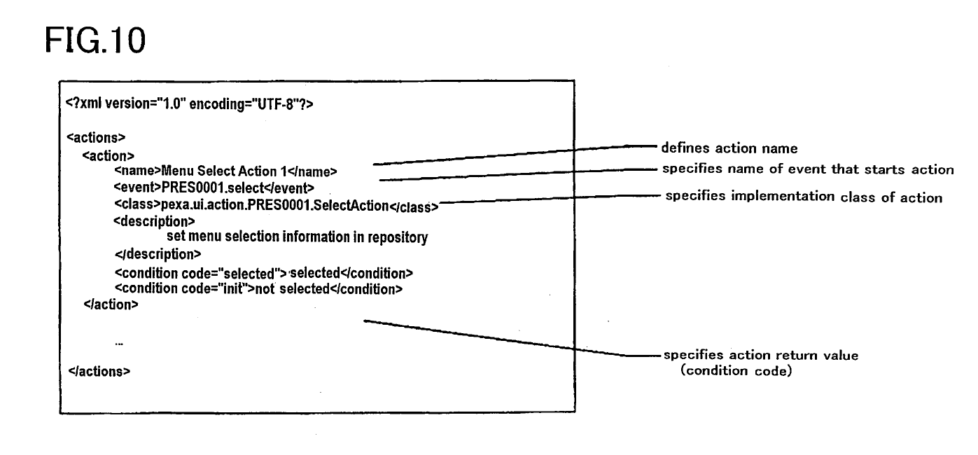

FIG. 10 is a diagram showing an example of the action definition XML file. The action name, event name, implementation class, and return value are defined.

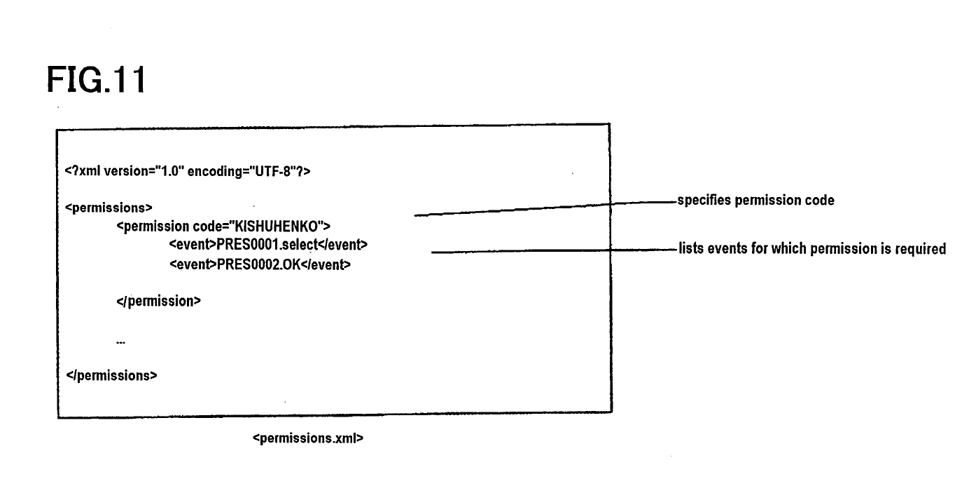

FIG. 11 is a diagram showing an example of the permission definition XML file.

In this file, the permission code and the events for which permission is required are listed.

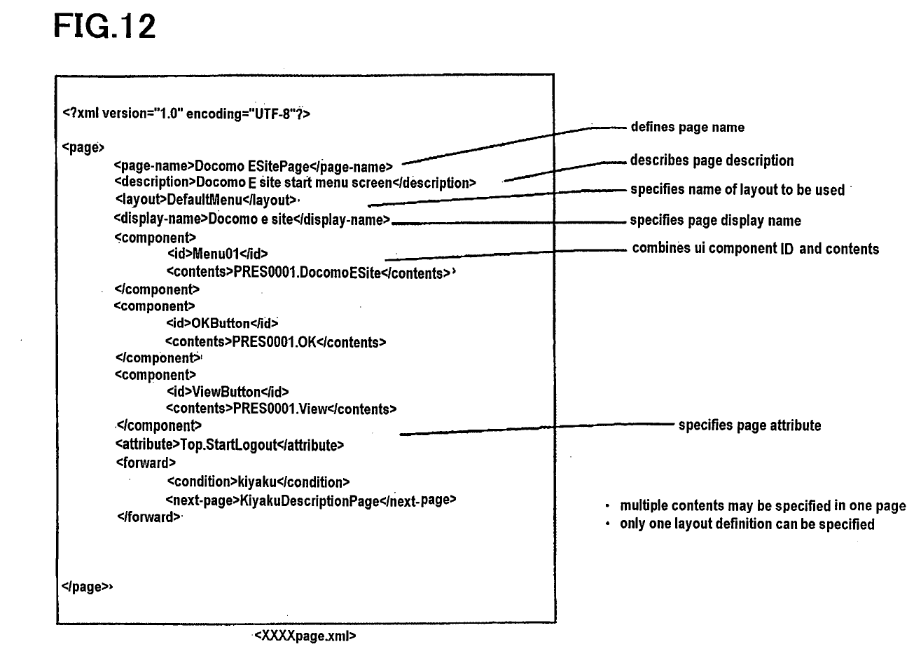

FIG. 12 is a diagram showing an example of the page definition XML file. In this file, the page name, the layout name that is used, the display name of the page, the combination of a UI component and contents, and the page attribute are defined. Multiple contents may be specified in one page and only one layout definition can be specified.

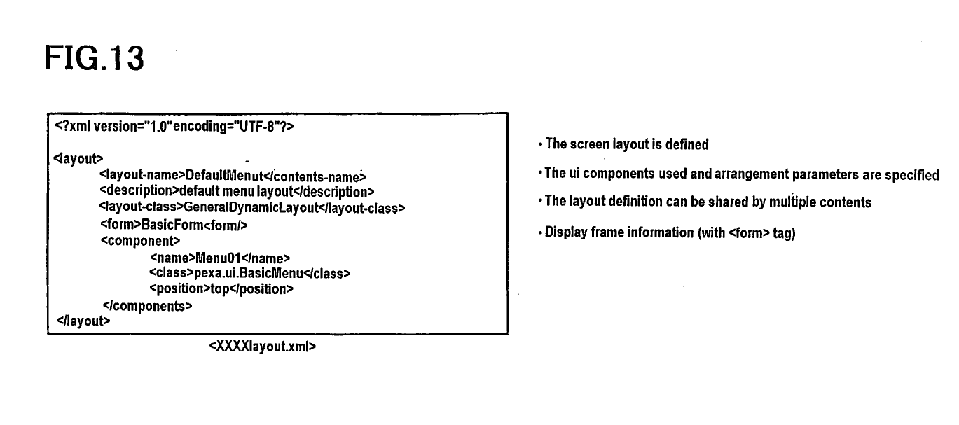

FIG. 13 is a diagram showing an example of the screen layout definition XML file that defines a screen layout. In this file, the screen layout, the UI components used, the arrangement parameters, and the display frame information (<form> tag) are defined. The layout definition may be shared by multiple contents.

<Client Control Feature>

The following describes the basic control feature (framework) for implementing and executing a client program in the present embodiment. The client control framework (called “client architecture”) is a framework for controlling the client part. The client architecture has the following functions.
Control program (controller);
Screen form;
UI component;
Simulation feature;
Debug feature; and
Test feature.

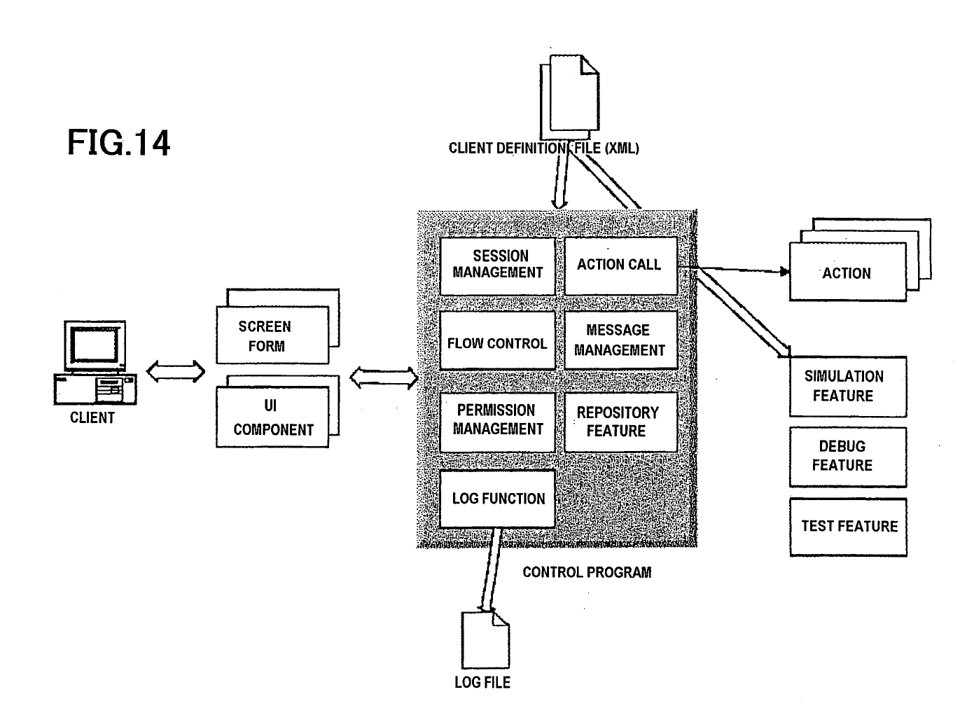

FIG. 14 is a diagram showing the client control feature. The following describes the functions.

<Control Program (Controller)>

The client architecture is created as an MVC (Model-View-Controller) structure, and the control program functions as this controller. The control program (controller) has the following functions.

(1) Session Management

The control program performs session management to manage a session from the time the operator logs into a client to the time the operator logs out. Through session management, the control program protects the context of the operator's dialog.

(2) Flow Control

The control program manages the transition of the screen. The control program performs this function to control the transition according to the description of a page definition defined in XML.

(3) Action Call

The control program calls an action, defined in the action definition XML file, in response to an operator's operation or a system event. The control program also performs this function to process the return value of an action if the processing for the return value is defined in the action definition XML file.

(4) Permission Management

The control program checks the permission of an action when it is called to limit the execution of the action. In addition, when a screen is displayed, the control program also performs this function to inhibit the user from selecting a function for which the user has no permission.

(5) Message Management

The control program manages the messages displayed on the screen. The message character strings may be managed for global use.

(6) Repository Feature

The repository feature function is provided for each session of the client. The control program uses this feature to save objects on a session basis or to pass data between client programs.

(7) Log Function

The control program manages the execution log.

<Screen Form>

A screen form is a standard part constituting the screen common frame. Each screen has one screen form. The screen form of a screen is defined in the page definition XML file.

There are the following types of screen form.

(1) Basic Screen Form

The basic screen form is a part in which all defaults of a screen form are defined.

(2) Extended Screen Form

The extended screen form is a part created by extending the basic screen form according to an enterprise.

<UI Component>

The UI components, GUI parts arranged for use in a screen form, are created corresponding to the stereotype of the contents of a client process.

The correspondence between the contents of a client process and the UI components displayed on the screen is defined in the page definition XML file. There are the following types of UI components.

(1) Basic UI Component

Basic UI components are prepared for stereotype types, one for each, with the default defined for the UI component of the stereotype.

(2) Extended UI Component

Extended UI components are created by extending basic UI components. When the shapes and functions of UI components vary according to an enterprise, basic UI components are extended to add functions.

<Simulation Feature>

To perform early design verification, the simulation feature allows the user to perform the operation verification or walkthrough before implementing actual actions with the XML information on the client design as its input. The feature simulates the client operation based on the XML-defined logical information.

<Debug Feature>

The debug feature has the following functions to help the user to debug the client.

(1) Real-Time Display of Client State

The debug feature displays the runtime state of the client in real time. The display items are as follows.
Session state;
Process ID in execution;
Page ID in execution;
Action ID in execution;
Action return value; and
Input field value.
   (2) Display of Repository

The debug feature displays the contents of the repository used by a client program for each session.

(3) Execution Log

The debug feature displays and saves the log during execution according to the level. The log may be turned on/off on a client program basis or on a message level basis.

(4) Server Function Simulation

Even when the server function is not implemented, the debug feature provides the function to simulate the server function. This server simulation function allows the user to debug the client independently without using the actual server.

<Test Feature (Regression Test)>

The test feature provides the user with the function to make a regression test necessary for program modification. This feature records the screen operation of a client to be executed and re-executes the operation.

The following describes the detailed parameters.

<Screen Stereotype>

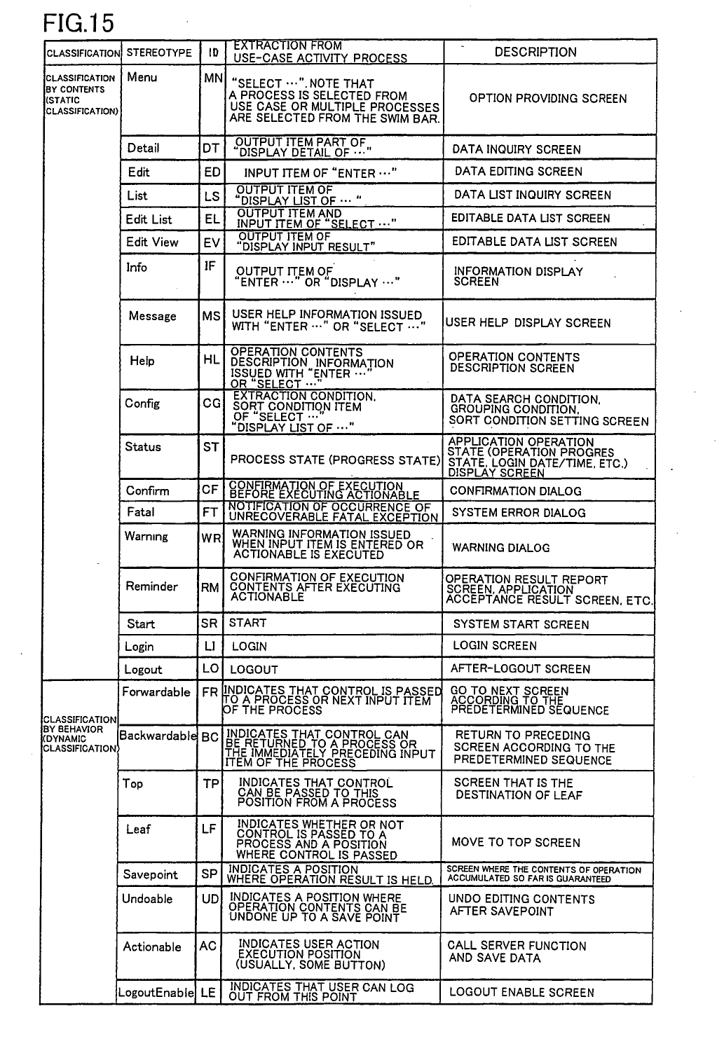

FIG. 15 is a diagram showing a list of screen stereotype examples.

For each of “classification by contents” and “classification by behavior”, the list contains “stereotype”, “ID”, “extraction from use-case activity process”, and “description”.

For example, when the extraction from use-case activity process is “select”, the stereotype Menu for the option-providing screen is provided. The stereotypes for the data inquiry screen, the editing screen, the list inquiry screen, the system start screen, the login screen, and after-logout screen are provided.

<GUI Standard Parts Definition>

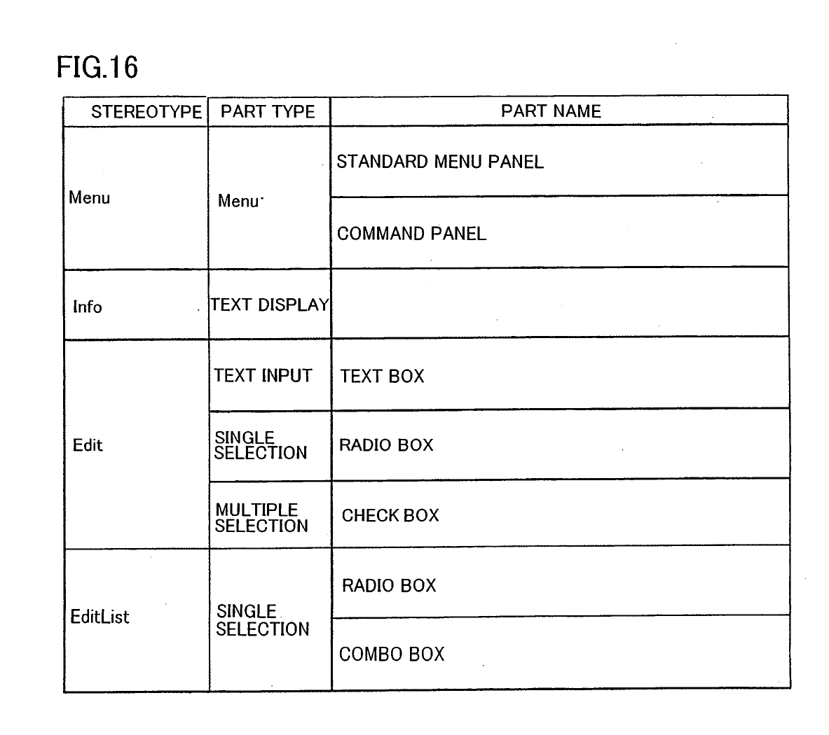

The GUI standard parts corresponding to the screen stereotypes are defined for each platform. The GUI standard parts are prepared as framework parts. FIG. 16 is a diagram showing an example of GUI standard parts.

<Contents Definition Elements>

When contents are defined, the elements necessary for the definition are determined for each stereotype.

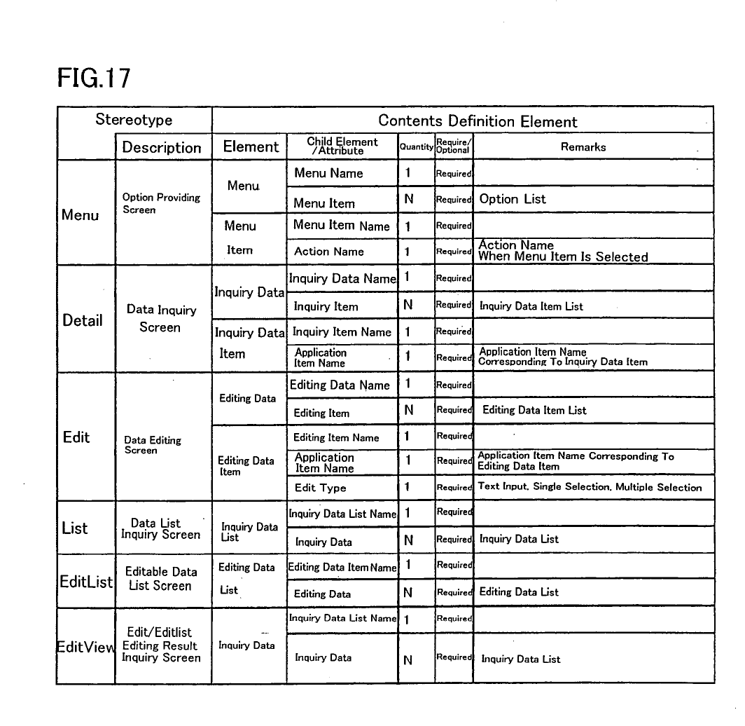

FIG. 17 is a diagram showing the contents definition elements. Menu, which is a selection providing screen, has a menu and a menu item as elements. The menu has a menu name and a menu item name as the child elements/attributes. The menu item has a menu item name and an action name at menu item selection time as the child elements/attributes.

Another embodiment of the present invention may be configured in such a way that means is provided for receiving a stereotype corresponding to the contents and converting it to a database (database server in FIG. 1) processing command (for example, SQL command) and then that processing command is issued to the database. In this configuration, the user need only to describe data manipulation design specifications with no need for directly generating SQL statements. For example, a search command, one of SQL commands, is generated based on a stereotype (for example, data search condition, grouping condition, sort condition setting screen in FIG. 15) corresponding to the data manipulation design specifications and the generated command is issued.

While the present invention has been described with reference to the embodiments above, it would be understood that the present invention is not limited to the embodiments above and that modifications and changes that may be made by those skilled in the art within the scope of the present invention are included.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An information processing apparatus comprising:
a first storage unit for storing design information defining design specifications of a target system to be built;
a second storage unit for storing a plurality of implementation parts used for a system implementation; and
a control unit, receiving the design information from said first storage unit, for controlling the implementation parts corresponding to said design information to automatically build the target system being adapted for operation, based on said design information.

2. The information processing apparatus according to claim 1, wherein said control unit includes
a virtual machine that implements the design information on a plurality of systems of different architectures using the same design information.

3. The information processing apparatus according to claim 1, wherein said design information includes at least definition information on client process, definition information of action, and definition information of action permission right.

4. The information processing apparatus according to claim 3, wherein said design information further includes:
definition information on a screen page; and
screen layout definition information corresponding to the page.

5. The information processing apparatus according to claim 1, wherein said implementation parts includes framework parts of a user interface, a screen layout, and an action program.

6. The information processing apparatus according to claim 3, further comprising simulation means for performing design operation verification based on the definition information before actually implementing said actions.

7. The information processing apparatus according to claim 1, further comprising means for debugging the target system to be built, based on the definition information.

8. The information processing apparatus according to claim 1, wherein said implementation parts include framework parts including user interfaces, screen layouts, and action programs; and
said control unit controls the framework parts corresponding to said design information and performs framework control to directly build the target system, based on the design information.

9. The information processing apparatus according to claim 4, further comprising means for redefining the page definition information and the screen layout to change specifications for the screen layout without changing original design information.

10. The information processing apparatus according to claim 3, wherein the client process has one or more contents, said client process setting a stereotype attribute which is prepared for each data list screen that can be edited, and input/output items required for the stereotype attribute.

11. The information processing apparatus according to claim 3, wherein the client process definition information includes a process name and a process ID, a contents name and a contents ID, a stereotype name, an enterprise item name, an enterprise rule, an action name, and inter-process transition information.

12. The information processing apparatus according to claim 3, wherein the action definition information includes an action name and processing to be executed.

13. The information processing apparatus according to claim 4, wherein the definition information on a screen page includes a page name, a client process, a screen layout, and page transition information.

14. The information processing apparatus according to claim 11, wherein the stereotype includes at least one of
a selection providing screen,
a data inquiry screen,
a data editing screen,
a data list inquiry screen,
an editable data list screen,
an edition result introduction screen,
an information display screen,
an operation contents description screen,
a data search condition, grouping condition, sort condition setting screen,
an enterprise operation state display screen,
a confirmation dialog,
a system error dialog,
a warning dialog,
a system start screen,
a login screen, and
an after-logout screen.

15. The information processing apparatus according to claim 11, wherein the stereotype includes at least one of a screen for transition among screens, a screen for canceling editing contents after a save point, a screen for calling a server function, a screen for saving data, and a screen for logging out.

16. The information processing apparatus according to claim 5, wherein GUI (Graphical User Interface) parts corresponding to screen stereotypes are provided as framework parts.

17. The information processing apparatus according to claim 1, further comprising means for receiving a stereotype corresponding to contents and for converting the stereotype to a processing command for a database, the processing command being issued to said database.

18. A method for system development using an information processing apparatus which includes a storage unit in which design information defining design specifications of a target system to be built is stored and a controller, wherein the design information includes client process definition information, action definition information, action permission right definition information, definition information on a screen page, and screen layout definition information corresponding to the page,
said method comprising the steps of:
said controller reading the design information from said storage unit;
said controller controlling framework parts including user interfaces, screen layouts, and action programs stored in a second storage unit; and
said controller performing framework control to directly implement the target system, based on the design information.
